(19) United States
(12) Patent Application Publication
(10) Pub. No.: US 2023/0004854 A1
(43) Pub. Date: Jan. 5, 2023

(54) ASYNCHRONOUS EDGE-CLOUD MACHINE LEARNING MODEL MANAGEMENT WITH UNSUPERVISED DRIFT DETECTION

(71) Applicant: EMC IP Holding Company LLC, Hopkinton, MA (US)

(72) Inventors: Tiago Salviano Calmon, London (GB); Jaumir Valenca da Silveira Junior, Rio de Janeiro (BR); Vinicius Michel Gottin, Rio de Janeiro (BR)

(21) Appl. No.: 17/363,235

(22) Filed: Jun. 30, 2021

(51) Int. Cl. G06N 20/00

(52) U.S. Cl. CPC G06N 20/00

(57) ABSTRACT

Techniques described herein relate to a method for updating ML models based on drift detection. The method may include training a ML model; storing the trained ML model associated with a confidence threshold and a fresh indication; receiving a drift signal from an edge node; making a determination, that drift is detected for the ML model; updating the trained ML model in the shared communication layer to be associated with a drifted indication; receiving batch data from edge nodes in response to the updating; generating an updated data set comprising previous data and the batch data; training the ML model using the updated data set; updating the trained ML model in the shared communication layer to be associated with an outdated indication; and storing, by the model coordinator, the updated trained ML model in the shared communication layer associated with a confidence threshold and a fresh indication.

### BACKGROUND

Computing devices often exist in environments that include many such devices (e.g., servers, virtualization environments, storage devices, mobile devices network devices, etc.). Machine learning algorithms may be deployed in such environments to, in part, assess data generated by or otherwise related to such computing devices. Such machine learning algorithms may be trained and/or executed on a central node, based on data generated by any number of edge nodes. Thus, data must be prepared and sent by the edge nodes to the central node. However, having edge nodes prepare and transmit data may use compute resources of the edge nodes and/or network resources that could otherwise be used for different purposes. Thus, it may be advantageous to employ techniques to minimize the work required of edge nodes and/or a network to provide data necessary to train and/or update a machine learning model on a central node.

### SUMMARY

In general, embodiments described herein relate to a method for updating machine learning (ML) models based on drift detection. The method may include training, by a model coordinator, a ML model using a historical data set to obtain a trained ML model; storing, by the model coordinator, the trained ML model in a shared communication layer associated with a first confidence threshold and a first fresh indication; receiving, by the model coordinator, a drift signal from an edge node of a plurality of edge nodes executing the trained ML model; making a determination, by the model coordinator and based on receiving the drift signal, that drift is detected for the trained ML model; updating, by the model coordinator, the trained ML model in the shared communication layer to be associated with a drifted indication; receiving, by the model coordinator, batch data from the plurality of edge nodes in response to the updating; generating, by the model coordinator, an updated historical data set comprising at least a portion of the historical data set and the batch data; training the ML model using the updated historical data set to obtain an updated trained ML model; updating, by the model coordinator, the trained ML model in the shared communication layer to be associated with an outdated indication; and storing, by the model coordinator, the updated trained ML model in the shared communication layer associated with a second confidence threshold and a second fresh indication.

In general, embodiments described herein relate to a non-transitory computer readable medium that includes computer readable program code, which when executed by a computer processor enables the computer processor to perform a method for updating machine learning (ML) models based on drift detection. The method may include training, by a model coordinator, a ML model using a historical data set to obtain a trained ML model; storing, by the model coordinator, the trained ML model in a shared communication layer associated with a first confidence threshold and a first fresh indication; receiving, by the model coordinator, a drift signal from an edge node of a plurality of edge nodes executing the trained ML model; making a determination, by the model coordinator and based on receiving the drift signal, that drift is detected for the trained ML model; updating, by the model coordinator, the trained ML model in the shared communication layer to be associated with a drifted indication; receiving, by the model coordinator, batch data from the plurality of edge nodes in response to the updating; generating, by the model coordinator, an updated historical data set comprising at least a portion of the historical data set and the batch data; training the ML model using the updated historical data set to obtain an updated trained ML model; updating, by the model coordinator, the trained ML model in the shared communication layer to be associated with an outdated indication; and storing, by the model coordinator, the updated trained ML model in the shared communication layer associated with a second confidence threshold and a second fresh indication.

In general, embodiments described herein relate to a system for updating machine learning (ML) models based on drift detection. The system may include a model coordinator, executing on a processor comprising circuitry, operatively connected to a shared communication layer and a plurality of edge nodes, and configured to: train a ML model using a historical data set to obtain a trained ML model; store the trained ML model in the shared communication layer associated with a first confidence threshold and a first fresh indication; receive a drift signal from an edge node of the plurality of edge nodes executing the trained ML model; make a determination, based on receiving the drift signal, that drift is detected for the trained ML model; update the trained ML model in the shared communication layer to be associated with a drifted indication; receive batch data from the plurality of edge nodes in response to the updating; generate an updated historical data set comprising at least a portion of the historical data set and the batch data; train the ML model using the updated historical data set to obtain an updated trained ML model; update the trained ML model in the shared communication layer to be associated with an outdated indication; and store the updated trained ML model in the shared communication layer associated with a second confidence threshold and a second fresh indication.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2A shows a flowchart in accordance with one or more embodiments of the invention.

FIG. 2B shows a flowchart in accordance with one or more embodiments of the invention.

FIG. 3 shows a computing system in accordance with one or more embodiments of the invention.

### DETAILED DESCRIPTION

Specific embodiments will now be described with reference to the accompanying figures.

In the below description, numerous details are set forth as examples of embodiments described herein. It will be understood by those skilled in the art, that also have the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to methods, systems, and non-transitory computer readable mediums storing instructions for training and updating models (e.g., machine learning (ML) models) at a central node (e.g., in the cloud) using data and other information from edge nodes. Specifically, one or more embodiments related to training an ML model at a central node, distributing the model to edge nodes, receiving indications from the edge nodes that model drift has occurred, obtaining new data from the edge nodes based on drift being detected, retraining the ML model, and re-distributing an updated model to the edge nodes.

At least in part due to computing workloads being performed all or in part at the edge portion of computing device ecosystems, and the corresponding decentralization of latency-sensitive application workloads, ML models that make use of both central nodes (e.g., computing devices in the cloud, data center, etc.) and edge devices operatively connected thereto may be desired. Thus, in one or more embodiments, a need for efficient management and deployment of such ML models arises. In one or more embodiments, efficient management implies, beyond model training and deployment, keeping the ML model coherent with the statistic distribution of input data of all edge nodes.

In one or more embodiments, to realize such a ML edge-to-cloud management system, it is important to note that, while model training could be performed on both edge nodes and central nodes, ML model execution will often be performed at the edge (e.g., due to latency constraints of time-sensitive applications). Moreover, different edge devices have different hardware configurations and connectivity and, thus, will communicate with the central node(s) at different time windows and with different frequencies.

Therefore, an efficient model management should take into account ML model performance at the edge nodes so that the ML model can be adjusted, rather than relying solely on central nodes to perform such tasks, which may, for example, incur significant data exchange, thereby increasing the networking costs of the application. In one or more embodiments, ML model performance at the edge may be monitored by determining whether drift has occurred. In one or more embodiments, drift of an ML model is when the results (e.g., predictions, classifications, etc.) become increasingly less accurate, unstable, erroneous, etc. However, detecting drift of ML models being executed on edge devices by a central node that trains and distributes the model would incur significant overhead due to the data at the edge nodes being sent (e.g., via a network) to the central node. Therefore, it may be desirable to detect drift at the edge nodes, and have the detection of drift communicated to the central node, which may then take actions based on drift detection to update the model. In one or more embodiments, drift detection techniques performed at the edge leverage computation already necessary for execution of ML models on edge nodes, and may be performed without direct supervision from the central node.

One or more embodiments described herein provide an asynchronous ML model management framework that encompasses ML model training at a central node and ML model execution at any number of edge nodes. In one or more embodiments, the framework is based, at least in part, on message passing between the central node and the edge nodes using metadata flags associated with ML models in a shared communication layer (e.g., a storage area accessible to both the central node and the edge nodes) to communicate models and status related thereto from the central node to the edge nodes.

In one or more embodiments, a central node trains an ML model to be executed at edge nodes to produce any number of results (e.g., predictions, classifications, etc.). In one or more embodiments, the central node stores the trained ML model in a shared communication layer accessible to the central node and to the edge nodes, and stores a fresh indication with the ML model to indicate to the edge nodes that the ML model is a fresh model. Additionally, during training and validation of the ML model, the central node determines a confidence value for the model that is a measure of the confidence that the results of the ML model are correct. In one or more embodiments, based on the confidence value, the central node obtains a confidence threshold. As an example, if a central node calculates that a given ML model has a confidence value of 95%, the central node may set the confidence threshold at 85% (e.g., 10% less than the confidence value). In one or more embodiments, the confidence threshold is also stored in the shared communication layer.

Next, in one or more embodiments, the edge nodes access the shared communication layer to obtain the trained ML model based on the fresh indication associated with the ML model, and also obtain the confidence threshold for the ML model. In one or more embodiments, the edge nodes then begin executing the ML model based on data generated by, obtained by, or otherwise available to the respective edge nodes. In one or more embodiments, as an edge node uses the ML model, the edge node performs an analysis to derive a confidence value for the model for results produced by the ML model based on the data of the edge node. In one or more embodiments, the edge node compares the confidence value to the confidence threshold obtained from the central node. In one or more embodiments, if the confidence value for the ML model at an edge node falls below the confidence threshold, then drift has occurred for the ML model. In one or more embodiments, in response to detecting that drift has occurred, the edge node sends a drift signal to the central node.

In one or more embodiments, the central node waits for edge nodes to send drift signals. In one or more embodiments, based on the drift signals, the central node determines when drift has occurred. Any number of drift signals may trigger the central node to determine drift has occurred. As an example, a single drift signal may be enough to cause the central node to determine that drift of the ML model has occurred. As another example, some aggregate number of drift signals from different edge nodes may be required, successive drift signals from one or more edge nodes, etc. One of ordinary skill in the art will appreciate that any number of drift signals in any time frame from any edge nodes may be set as the trigger for a central node to decide that drift of an ML model has occurred without departing from the scope of embodiments described herein.

In one or more embodiments, once the central node has determined that the ML model has drifted, the central node updates the model in the shared communication layer to be associated with a drifted indication instead of a fresh indication. In one or more embodiments, the edge nodes are configured to periodically check the shared communication layer to determine the status of the ML model they are executing. In one or more embodiments, if an edge node determines that the ML model the edge node is using is marked as drifted, the edge node begins a batch collection mode. In one or more embodiments, each set of input data for an ML model may be referred to as a batch. In one or more embodiments, when in batch collection mode, triggered by a model being marked as outdated, an edge node begins transmitting batch data to the central node. In one or more embodiments, the edge node continues to execute the ML model, collect data, and transmit data to the central node until the ML model the edge node is executing becomes marked with an outdated indication in the shared communication layer. In one or more embodiments, once an edge node determines that the ML model it is executing has been marked as outdated, the edge node stops executing the model, stops collecting and transmitting batch data to the central node, and obtains a new ML model from the shared communication layer that is associated with a fresh indication.

In one or more embodiments, after marking a ML model with a drifted indication in the shared communication layer, the central node begins receiving the aforementioned batch data from the various edge nodes as they determine that the model is marked as drifted. Any amount of batch data from the edge nodes may be received by the central node while the edge nodes are in batch collection mode. In one or more embodiments, once enough new data has been received from the edge nodes, the central node retrains the ML model using, at least in part, the new data. Any amount of new data from any number of edge nodes may be considered enough data to trigger retraining of the ML model. All or any portion of the new data may be used in a new training data set, which may or may not be combined with all or any portion of the previous training set to obtain a new training set to retrain the ML model. In one or more embodiments, the central node retrains and validates the ML model using the new training data, and calculates a new confidence value and corresponding confidence threshold. In one or more embodiments, once the ML model is retrained, the central node changes the indication on the previous model in the shared communication layer from drifted to outdated, stores the updated model associated with a fresh indication, and stores the new confidence threshold. In one or more embodiments, the edge nodes periodically check the shared communication layer, and as they see the new fresh model, and the previous model as outdated, the edge nodes obtain the new model and the new confidence threshold and begin executing the updated ML model. Thus, in one or more embodiments, the process continues, with the edge node drift detection and corresponding actions of the central node to continuously manage the ML model to avoid drift of the ML model relative to the data at the edge nodes.

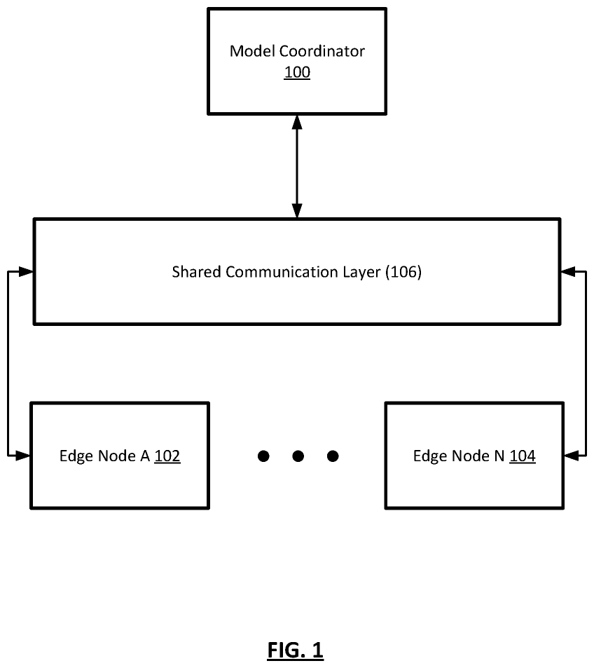

FIG. 1 shows a diagram of a system in accordance with one or more embodiments described herein. The system may include a model coordinator (100) operatively connected to any number of edge nodes (e.g., edge node A (102), edge node N (104)) via, at least in part, a shared communication layer (106). Each of these components is described below.

In one or more embodiments, the edge nodes (102, 104) may be computing devices. In one or more embodiments, as used herein, an edge node (102, 104) is any computing device, collection of computing devices, portion of one or more computing devices, or any other logical grouping of computing resources.

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, an enterprise data storage array etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device or edge node (102, 104). Other types of computing devices may be used as edge nodes without departing from the scope of embodiments described herein.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g. circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

In one or more embodiments, an edge node (102, 104) includes functionality to generate or otherwise obtain any amount or type of data (e.g., telemetry data, feature data, image data, etc.) that is related in any way to the operation of the edge device. As an example, a storage array edge device may include functionality to obtain feature data related to data storage, such as read response time, write response time, number and/or type of disks (e.g., solid state, spinning disks, etc.), model number(s), number of storage engines, cache read/writes and/or hits/misses, size of reads/writes in megabytes, etc.

In one or more embodiments, the system also includes a model coordinator (100). In one or more embodiments, the model coordinator (100) is operatively connected to the edge nodes (102, 104). A model coordinator (100) may be separate from and connected to any number of edge nodes (102, 104). In one or more embodiments, the model coordinator (100) is a computing device (described above). As an example, a model coordinator may be a central node executing in a cloud computing environment and training and distributing a ML model to any number of edge nodes (102, 104).

In one or more embodiments, the edge nodes (102, 104) and the model coordinator (100) are operatively connected via, at least in part, a network (not shown). A network may refer to an entire network or any portion thereof (e.g., a logical portion of the devices within a topology of devices). A network may include a datacenter network, a wide area network, a local area network, a wireless network, a cellular phone network, or any other suitable network that facilitates the exchange of information from one part of the network to another. A network may be located at a single physical location, or be distributed at any number of physical sites. In one or more embodiments, a network may be coupled with or overlap, at least in part, with the Internet.

In one or more embodiments, the edge nodes (102, 104) and the model coordinator (100) are also operatively connected, at least in part, via a shared communication layer (106). In one or more embodiments, a shared communication layer (106) is any computing device, set of computing devices, portion of a computing device, etc. that is accessible to the model coordinator (100) and the edge nodes (102, 104), and includes functionality to store data. In one or more embodiments, data stored by the shared communication layer may include, but is not limited to, trained ML models, indications indicating whether a given ML model is fresh, drifted, or outdated, and confidence thresholds associated with ML models. In one or more embodiments, such data is stored on the shared communication layer by a model coordinator (100), and the stored data is accessed and/or obtained by any number of edge nodes (102, 104). The shared communication layer (106) may be separate from the model coordinator (100) and the edge nodes (102, 104), may be implemented as a portion of the model coordinator, may be a shared storage construct distributed among the edge nodes and/or the model coordinator, any combination thereof, or any other data storage solution accessible to the edge nodes and the model coordinator.

While FIG. 1 shows a configuration of components, other configurations may be used without departing from the scope of embodiments described herein. Accordingly, embodiments disclosed herein should not be limited to the configuration of components shown in FIG. 1.

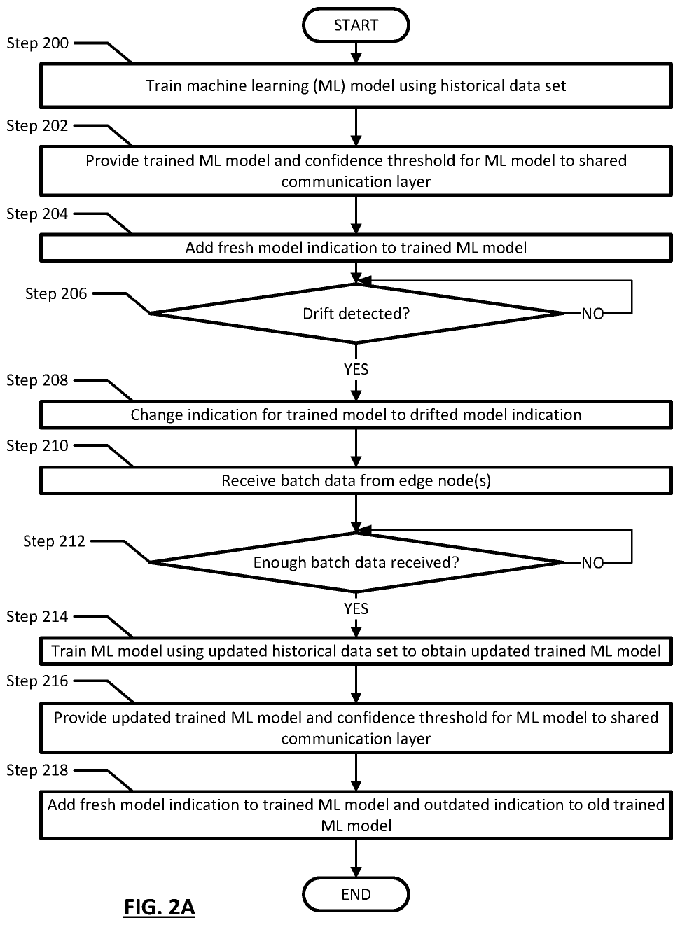

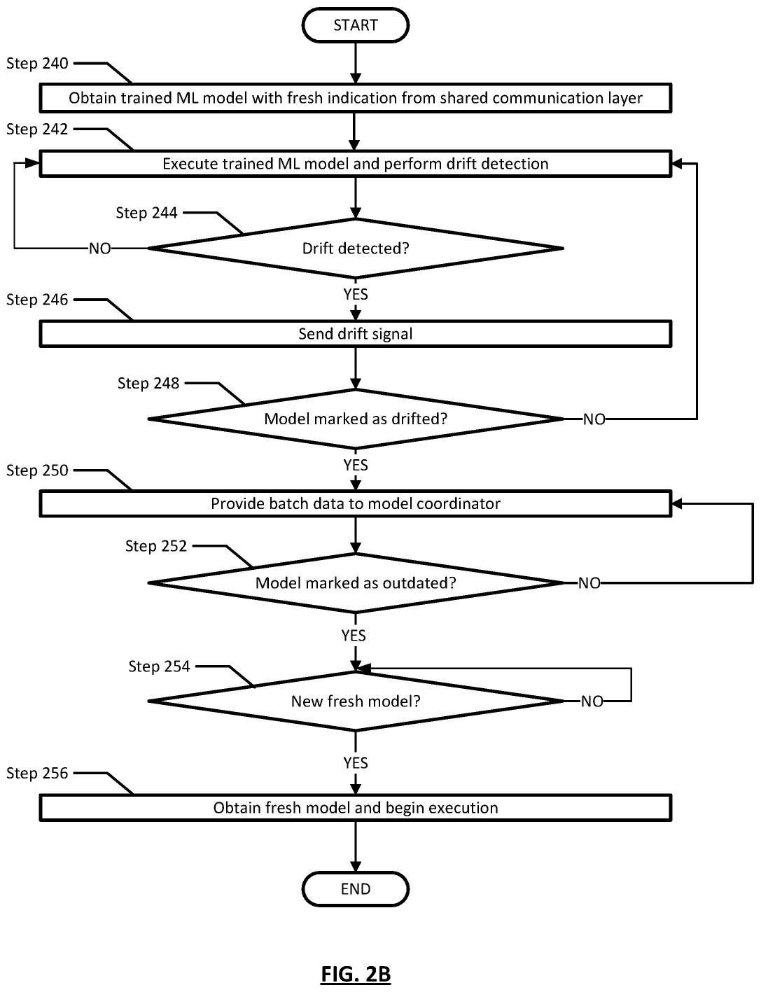

FIG. 2A shows a flowchart describing a method for ML model management by a model coordinator using edge node drift detection in accordance with one or more embodiments disclosed herein.

While the various steps in the flowchart shown in FIG. 2A are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel with other steps of FIG. 2A.

In Step 200, a model coordinator trains and validates an ML model using a historical data set. In one or more embodiments, the ML model may be any type of ML model (e.g., random forest, regression, neural network, etc.) capable of producing one or more results relevant to edge nodes that execute the ML model. In one or more embodiments, data of any type or quantity is available to a model coordinator and related to a particular problem domain to which a ML model is to be applied. As an example, the historical data set may be a large amount of telemetry data from different storage arrays that can be used to predict the performance of some aspect of the storage arrays. In one or more embodiments, training the ML model includes providing all or any portion of the historical data set as input to a ML model to train the ML model to produce accurate results based on the inputs. Training a ML model may include any number of iterations, epochs, etc. without departing from the scope of embodiments described herein. In one or more embodiments, training an ML model also includes validating the training to determine how well the ML model is performing relative to the historical data set, some of which may have been separated from the training portion to be used in validation.

In one or more embodiments, as part of training the ML model, the model coordinator also calculates a confidence value for the trained ML model. Any scheme for determining a threshold value for an ML model may be used without departing from the scope of embodiments described herein. As an example, the ML model may be a neural network. In one or more embodiments, for such an ML model, the first stage of calculating a confidence value relates to the collection of confidence levels in the results (e.g., inferences) over the training data set. In one or more embodiments, after the ML model is trained, the training set is used again to obtain the values of the softmax layer for each sample. In one or more embodiments, the aggregated values of the softmax layer of the sample set are the confidence levels. In this example the resulting confidence γ of the inference (the class with higher probability) of a sample is obtained. In one or more embodiments, an aggregate statistic p of the confidence over the whole training dataset is updated accordingly. In a typical embodiment, this statistic may comprise the mean prediction confidence of all inferences. The mean may be updated on a sample-by-sample basis if the number of samples already considered, k, is kept in memory and incremented accordingly (i.e., for each sample, μ←μ+γ/k and k←k+1 when k>0; μ←γ otherwise).

In one or more embodiments, the process of obtaining the confidence for each sample and updating an aggregate statistic may be performed online with respect to training, as batches of samples are processed, or offline, after a resulting trained model is obtained. In certain embodiments, it may be advantageous to consider only the confidence levels in inferences that are correct (e.g., that result in the prediction of the true label for the sample). In one or more embodiments, if the overall error of the model is very small this may not significantly impact the statistic p; however, for models with lower accuracy, considering only the true predictions may result in a significantly higher value for the inference confidences (i.e., the model will likely assign higher confidences to the inferences of easier cases, that it is able to correctly classify or predict).

In one or more embodiments, the confidence value (e.g., μ in the above example) is used to derive a confidence threshold (e.g., t) for the ML model. In one or more embodiments, the confidence threshold represents an aggregate confidence of the model on the results (e.g., inferences) produced based on the training dataset that, if confidence values at the edge nodes fall below, indicates that the ML model has drifted at such edge nodes. In one or more embodiments, the confidence threshold may be determined as a fraction (or factor) of the confidence value; or the confidence value adjusted by a constant factor.

In Step 202, the model coordinator provides the trained ML model and the confidence threshold to a shared communication layer. In one or more embodiments, the confidence threshold and the trained ML model may be provided to the shared communication layer using any means of conveying data from one device or portion thereof to another device, portion of the same device, etc. As an example, the model coordinator may transmit the trained ML model and the confidence threshold to the shared communication layer via a network to be stored in storage of the shared communication layer. In one or more embodiments, the trained ML model and the confidence threshold are associated with one another in the shared communication layer.

In Step 204, a fresh indication is associated with the trained ML model in the shared communication layer. In one or more embodiments, an indication is any data capable of being associated with another item of data and indicating a status related to the other data item. In one or more embodiments, a fresh indication is an indication that the trained ML model has not yet had drift detected at any of the edge nodes that obtain and execute the ML model.

In Step 206, the model coordinator makes a determination as to whether drift has been detected. Drift detection by the edge nodes is discussed further in the description of FIG. 2B, below. In one or more embodiments, when an edge node detects drift of the trained ML model obtained from a shared communication layer, the edge node sends a drift signal to the model coordinator. The drift signal may be any signal capable of conveying information from an edge node to a model coordinator. As an example, a drift signal may be a message set using a network protocol from an edge node to the model coordinator. The model coordinator may use any number of drift signals to determine that drift is detected. As an example, a single drift signal from a single edge node may cause the model coordinator to determine that drift is detected. As another example, a drift signal from a pre-defined number of edge nodes may cause the model coordinator to determine that drift is detected. As another example, a series of drift signals from the same edge node or edge nodes over a certain amount of time may cause the model coordinator to determine that drift is detected. In one or more embodiments, if drift has not been detected, the method remains at Step 206, and the model coordinator continues to wait for drift signals from the edge nodes. In one or more embodiments, if the model coordinator determines that drift is detected, the method proceeds to Step 208.

In Step 208, the model coordinator changes the indication associated with the ML model in the shared communication layer from a fresh indication to a drifted indication. In one or more embodiments, a drifted indication associated with a ML model indicates that the model coordinator has determined that drift is detected for the ML model (see Step 206). In one or more embodiments, the change of the indication for the ML model from fresh to drifted is obtained by the edge nodes at any time. For example, each edge node may periodically check the shared communication layer to obtain an updated status for the ML model. At such times, the edge nodes may become aware that a ML model they are executing has been associated with a drifted indication.

In Step 210, the model coordinator begins receiving batch data from the edge nodes, which the edge nodes begin sending in response to determining that a model has been marked with a drifted indication. In one or more embodiments, batch data is sets of data used as inputs for a ML model being executed at the edge nodes. The model coordinator may receive the batch data via any technique for obtaining information from the edge nodes. As an example, the edge nodes, in response to seeing that the ML model has a drifted indication, may begin storing batch data in the shared communication layer, and the model coordinator may obtain the stored batch data from the shared communication layer.

In Step 212, the model coordinator makes a determination as to whether enough batch data has been received from the edge nodes. In one or more embodiments, the model coordinator waits for and collects the batch data sent by the edge nodes. In one or more embodiments, the model coordinator periodically evaluates whether the collected batch data is sufficiently representative for the training of a new ML model. In one or more embodiments, such evaluation may include an active analysis of the characteristics of the batch data in comparison to the historical data set; or an assessment of the variety of the data with respect to the edge nodes of origin (e.g., the model coordinator may require batches from a majority or plurality of the edge nodes). In some embodiments, the model coordinator may only consider or otherwise favor in a predetermined proportion the batch data from edge nodes that have sent drift signals. In one or more embodiments, a determination as to whether enough batch data has been obtained includes, at least, a minimum number of batches collected. In one or more embodiments, the model coordinator waits until a minimum number of batches are collected, without considering any additional requirements. In one or more embodiments, if enough batch data has not been received, the method remains at Step 212, and the model coordinator waits for more batch data from the edge nodes. In one or more embodiments, if enough batch data has been received, the method proceeds to Step 214.

In Step 214, the model coordinator trains a new ML model (or re-trains the ML model) using an updated historical data set. In one or more embodiments, regardless of the method for the batch collection, when the model coordinator assesses that a representative set of batch data has been collected, the model coordinator proceeds to produce a new training data set, which may be referred to as an updated historical data set. In one or more embodiments, the updated historical data set includes a combination of the previously available historical data set and the new batch data. The techniques for such combination may vary. As an example, only a most-recent set of historical data may be considered. As another example, with m samples in the historical dataset and after the collection of new batches comprising n samples, the updated historical data set may be composed of the new batches appended to the m-n most recent samples from the historical dataset. In one or more embodiments, once the model coordinator has generated the updated historical data set, the model coordinator trains and validates the ML model using the updated historical data set to produce an updated ML model, and calculates a new confidence threshold for the updated ML model (see Step 200).

In Step 216, the model coordinator provides the updated trained ML model and the associated confidence threshold to a shared communication layer. In one or more embodiments, the confidence threshold and the updated trained ML model may be provided to the shared communication layer using any means of conveying data from one device or portion thereof to another device, portion of the same device, etc. As an example, the model coordinator may transmit the updated trained ML model and the confidence threshold to the shared communication layer via a network to be stored in storage of the shared communication layer. In one or more embodiments, the trained ML model and the confidence threshold are associated with one another in the shared communication layer.

In Step 218, a fresh indication is associated with the updated trained ML model in the shared communication layer. In one or more embodiments, the previous ML model, which was previously marked as drifted in Step 208, is changed from having a drifted indication to having an outdated indication. In one or more embodiments, an outdated indication means that a newer updated ML model is available, and that edge nodes should cease using the ML model having the outdated indication. In one or more embodiments, the edge nodes periodically check the status of the ML model being used, and stop using a ML model when they become aware that it is associated with an outdated indication. In one or more embodiments, at such time, the edge nodes also obtain the updated trained ML model associated with a fresh indication.

FIG. 2B shows a flowchart describing a method for ML model management by an edge node in accordance with one or more embodiments disclosed herein.

While the various steps in the flowchart shown in FIG. 2B are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel with other steps of FIG. 2B.

In Step 240, an edge node obtains a trained ML model from a shared communication layer, along with an associated confidence threshold. In one or more embodiments, the trained ML model was stored in the shared communication layer by a model coordinator (see, e.g., FIG. 2A).

In Step 242, the edge node executes the trained ML model using data available to the edge node, and performs drift detection. In one or more embodiments, the trained ML model may be any trained ML model used for any purpose (e.g., inference). In one or more embodiments, the data used to execute the trained ML model may be any data relevant to the edge node (e.g., telemetry data, user data, etc.). In one or more embodiments, the edge node performs drift detection by comparing a confidence value calculated for the trained ML model with the confidence threshold calculated by the model coordinator and obtained from the shared communication layer. In one or more embodiments, an edge node calculates a confidence value for the trained ML model using techniques similar to that described with respect to the model coordinator in Step 200, above.

In Step 244, the edge node determines if drift is detected on that edge node. In one or more embodiments, drift is detected when the confidence value calculated for the trained ML model in Step 242 is less than the confidence threshold associated with the trained ML model obtained in Step 240. In one or more embodiments, if drift is detected at the edge node, the method proceeds to Step 246. In one or more embodiments, if drift is not detected, the method returns to Step 242, and the edge node continues to execute the trained ML model and perform drift detection.

In Step 246, based on the determination in Step 244 that drift has occurred for the ML model, the edge node sends a drift signal to the model coordinator. The drift signal may be sent using any means of conveying information. As an example, the drift signal may be sent as one or more network packets.

In Step 248, a determination is made as to whether the trained ML model being executed by the edge node is associated with a drifted indication. In one or more embodiments, on any schedule, the edge nodes check the shared communication layer to determine the status of the trained ML model they are executing. The trained ML model may be associated with a drifted indication when the model coordinator has determined that drift is detected, as described above in Step 206 of FIG. 2A. In one or more embodiments, if the edge node determines that the trained ML model is not associated with a drifted signal in the shared communication layer, the method returns to Step 242 and the edge node continues to execute the trained ML model, perform drift detection, and send drift signals when drift is detected. In one or more embodiments, if an edge node determines that the trained ML model is associated with a drifted indication, the method proceeds to Step 250.

In Step 250, based on a determination in Step 248 that the trained ML model being executed is associated with a drifted indication, the edge node begins sending batch data to the central node. In one or more embodiments, batch data is any data available to the edge node that is being used to execute the trained ML model. The batch data may be sent using any technique for transmitting data. As an example, the edge node may store the batch data in the shared communication layer, from which it may be obtained by the model coordinator.

In Step 252, a determination is made as to whether the trained ML model it is executing is associated with an outdated indication in the shared communication layer. In one or more embodiments, the edge node periodically checks the status of the trained ML model being executed by checking the associated indication in the shared communication layer. In one or more embodiments, when the edge node determines that the trained ML model is associated with an outdated indication, the method proceeds to Step 254. In one or more embodiments, if the edge node has not determined that the trained ML model is associated with an outdated indication, the method returns to Step 250, and the edge node continues to provide batch data to the model coordinator.

In Step 254, a determination is made as to whether an updated trained ML model associated with a fresh indication is available. In one or more embodiments, after determining that a trained ML model being executed is associated with an outdated indication in Step 252, the edge node checks to determine if an updated trained ML model associated with a fresh indication is available in the shared communication layer. In one or more embodiments, if no such model is present, the method remains at Step 254, and the edge node periodically rechecks for such a ML model. In one or more embodiments, if an updated trained ML model associated with a fresh indication is available, the method proceeds to Step 256.

In Step 256, the edge node obtains the updated trained ML model associated with the fresh indication and begins executing the updated trained ML model.

Example Use Case

The above describes systems and methods for training an ML model, distributing the model to edge nodes, determining if drift is detected based on drift signals from edge nodes, and, when drift is detected, obtaining batch data to train a new ML model to distribute to the edge nodes. As such, one of ordinary skill in the art will recognize that there are many variations of how such ML model management may occur, as is described above. However, for the sake of brevity and simplicity, consider the following simplified scenario to illustrate the concepts described herein.

Consider a scenario in which a model coordinator is operatively connected to ten edge nodes via a shared communication layer for storing data. In such a scenario, the model coordinator trains and validates an ML model, and calculates a confidence value for the trained ML model. Next, the model coordinator derives a confidence threshold of 89% for the trained ML model based on the confidence value.

The trained ML model and the associated confidence threshold are then stored in a shared communication layer that is accessible by the model coordinator and the edge nodes. The trained ML model is associated in the shared communication layer with a fresh indication.

Next, the edge nodes each obtain the trained ML model and the confidence threshold from the shared communication layer, and begin executing the trained ML model. While executing the trained ML model, the edge nodes perform drift detection by calculating a confidence value for the trained ML model, and comparing the confidence value with the confidence threshold.

Sometime later, edge node 3 determines that the confidence value for the trained ML model is less than 89%. Therefore, edge node 3 sends a drift signal to the model coordinator. The model coordinator is configured to determine that drift is detected if four of the ten edge nodes send a drift signal, so it does not yet take any action in response to the drift signal from edge node 3. A short while later, three more edge nodes detect drift and send a drift signal to the model coordinator. Having now received drift signals from four edge nodes, the model coordinator changes the indication associated with the trained ML model in the shared communication layer from fresh to drifted.

Next, each of the edge nodes, at different times, check the status of the trained ML model and become aware that it is associated with a drifted indication. In response the edge nodes begin providing batch data to the model coordinator by way of the shared communication layer. Once enough batch data is received, the model coordinator retrains the ML model using an updated historical data set that includes a combination of the batch data received from the edge nodes and the data previously used to train the ML model. Additionally, the model coordinator generates a new confidence threshold associated with the updated trained ML model, and stores the updated trained ML model and confidence threshold in the shared communication layer. The updated trained model is associated with a fresh indication, and the old trained ML model is changed to an outdated indication.

Each of the edge nodes, at different times, check the shared communication layer and become aware that the trained ML model they are using is associated with an outdated indication. In response, they check the shared communication layer for an updated trained ML model associated with a fresh indication. Upon finding such a model, they obtain the updated trained ML model, and begin using said model.

End of Example Use Case

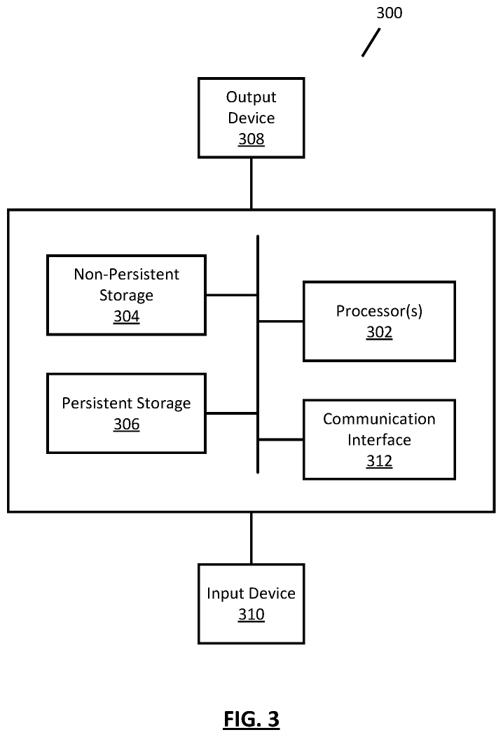

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for updating machine learning (ML) models based on drift detection, the method comprising:
training, by a model coordinator, a ML model using a historical data set to obtain a trained ML model;
storing, by the model coordinator, the trained ML model in a shared communication layer associated with a first confidence threshold and a first fresh indication;
receiving, by the model coordinator, a drift signal from an edge node of a plurality of edge nodes executing the trained ML model;
making a determination, by the model coordinator and based on receiving the drift signal, that drift is detected for the trained ML model;
updating, by the model coordinator, the trained ML model in the shared communication layer to be associated with a drifted indication;
receiving, by the model coordinator, batch data from the plurality of edge nodes in response to the updating;
generating, by the model coordinator, an updated historical data set comprising at least a portion of the historical data set and the batch data;
training the ML model using the updated historical data set to obtain an updated trained ML model;
updating, by the model coordinator, the trained ML model in the shared communication layer to be associated with an outdated indication; and
storing, by the model coordinator, the updated trained ML model in the shared communication layer associated with a second confidence threshold and a second fresh indication.

2. The method of claim 1, wherein the edge node sends the drift signal based on the determination that an edge node confidence value associated with execution of the trained ML model is lower than the first confidence threshold.

3. The method of claim 1, wherein the batch data is provided from the plurality of edge nodes to the model coordinator using the shared communication layer.

4. The method of claim 1, wherein, based on the outdated indication being associated with the trained ML model, the plurality of edge nodes obtain and execute the updated trained ML model.

5. The method of claim 1, wherein the determination based on receiving the drift signal is made after receiving a plurality of other drift signals, and wherein the drift signal and the plurality of other drift signals are a quantity equal to a minimum threshold of drift signals required for drift detection.

6. The method of claim 1, further comprising, before generating the updated historical data set, making a second determination, by the model coordinator, that a required amount of batch data has been received from the plurality of edge nodes.

7. The method of claim 1, wherein:
the first confidence threshold is a percentage of a confidence value associated with the trained ML model, and
the confidence value is obtained by using an arbitrary statistic of values of a softmax layer associated with the trained ML model.

8. A non-transitory computer readable medium comprising computer readable program code, which when executed by a computer processor enables the computer processor to perform a method for updating machine learning (ML) models based on drift detection, the method comprising:
training, by a model coordinator, a ML model using a historical data set to obtain a trained ML model;
storing, by the model coordinator, the trained ML model in a shared communication layer associated with a first confidence threshold and a first fresh indication;
receiving, by the model coordinator, a drift signal from an edge node of a plurality of edge nodes executing the trained ML model;
making a determination, by the model coordinator and based on receiving the drift signal, that drift is detected for the trained ML model;
updating, by the model coordinator, the trained ML model in the shared communication layer to be associated with a drifted indication;
receiving, by the model coordinator, batch data from the plurality of edge nodes in response to the updating;
generating, by the model coordinator, an updated historical data set comprising at least a portion of the historical data set and the batch data;
training the ML model using the updated historical data set to obtain an updated trained ML model;
updating, by the model coordinator, the trained ML model in the shared communication layer to be associated with an outdated indication; and
storing, by the model coordinator, the updated trained ML model in the shared communication layer associated with a second confidence threshold and a second fresh indication.

9. The non-transitory computer readable medium of claim 8, wherein the edge node sends the drift signal based on the determination that an edge node confidence value associated with execution of the trained ML model is lower than the first confidence threshold.

10. The non-transitory computer readable medium of claim 8, wherein the batch data is provided from the plurality of edge nodes to the model coordinator using the shared communication layer.

11. The non-transitory computer readable medium of claim 8, wherein, based on the outdated indication being associated with the trained ML model, the plurality of edge nodes obtain and execute the updated trained ML model.

12. The non-transitory computer readable medium of claim 8, wherein the determination based on receiving the drift signal is made after receiving a plurality of other drift signals, and wherein the drift signal and the plurality of other drift signals are a quantity equal to a minimum threshold of drift signals required for drift detection.

13. The non-transitory computer readable medium of claim 8, wherein the method performed by executing the computer readable program code further comprises, before generating the updated historical data set, making a second determination, by the model coordinator, that a required amount of batch data has been received from the plurality of edge nodes.

14. The non-transitory computer readable medium of claim 8, wherein the first confidence threshold is a fraction of a confidence value associated with the trained ML model.

15. A system for updating machine learning (ML) models based on drift detection, the system comprising:
a model coordinator, executing on a processor comprising circuitry, operatively connected to a shared communication layer and a plurality of edge nodes, and configured to:
train a ML model using a historical data set to obtain a trained ML model;
store the trained ML model in the shared communication layer associated with a first confidence threshold and a first fresh indication;
receive a drift signal from an edge node of the plurality of edge nodes executing the trained ML model;
make a determination, based on receiving the drift signal, that drift is detected for the trained ML model;
update the trained ML model in the shared communication layer to be associated with a drifted indication;
receive batch data from the plurality of edge nodes in response to the updating;
generate an updated historical data set comprising at least a portion of the historical data set and the batch data;
train the ML model using the updated historical data set to obtain an updated trained ML model;
update the trained ML model in the shared communication layer to be associated with an outdated indication; and
store the updated trained ML model in the shared communication layer associated with a second confidence threshold and a second fresh indication.

16. The system of claim 15, wherein the edge node sends the drift signal based on the determination that an edge node confidence value associated with execution of the trained ML model is lower than the first confidence threshold.

17. The system of claim 15, wherein the batch data is provided from the plurality of edge nodes to the model coordinator using the shared communication layer.

18. The system of claim 15, wherein, based on the outdated indication being associated with the trained ML model, the plurality of edge nodes obtain and execute the updated trained ML model.

19. The system of claim 15, wherein the determination based on receiving the drift signal is made after receiving a plurality of other drift signals, and wherein the drift signal and the plurality of other drift signals are a quantity equal to a minimum threshold of drift signals required for drift detection.

20. The system of claim 15, wherein, before generating the updated historical data set, the model coordinator is further configured to make a second determination that a required amount of batch data has been received from the plurality of edge nodes.
